(19) United States
(12) Patent Application Publication
(10) Pub. No.: US 2026/0204864 A1
(43) Pub. Date: Jul. 16, 2026

(54) CLADDING-PUMPED FIBER LASER WITH TAPERED PUMP RECYCLER

(71) Applicant: Corelase Oy, Tampere (FI)

(72) Inventor: Arto SALOKATVE, Tampere (FI)

(73) Assignee: Corelase Oy, Tampere (FI)

(21) Appl. No.: 19/016,719

(22) Filed: Jan. 10, 2025

(51) Int. Cl. H01S 3/094

(52) U.S. Cl. CPC H01S 3/094015; H01S 3/094007

(57) ABSTRACT

A cladding-pumped fiber laser includes a fiber-optic laser resonator and a tapered rod to recycle residual pump light not absorbed by a gain fiber of the laser resonator. The tapered rod includes a proximal end arranged to receive the residual pump light from the gain fiber via a fiber-optic end mirror of the laser resonator, and a distal end, opposite the proximal end, having a reflective coating to at least partly reflect the residual pump laser light in direction back towards the gain fiber. A cross-sectional area of the tapered rod adiabatically increases from a smaller area at the proximal end to a larger area at the distal end, resulting in reduced power density and numerical aperture of the residual pump light at the distal end. The reduced power density allows for recycling of high-power pump light. The reduced numerical aperture is advantageous for the reflective-coating design.

### TECHNICAL FIELD

The present invention relates in general to cladding-pumped fiber lasers. The present invention relates in particular to high-power, cladding-pumped fiber lasers subject to a trade-off between maximizing pump-power utilization and minimizing undesirable nonlinear effects such as stimulated Raman scattering.

### DISCUSSION OF BACKGROUND ART

A fiber laser is a solid-state laser that utilizes an optical fiber as the laser gain medium. This optical fiber, referred to as the “gain fiber”, has a core doped with rare-earth ions. Pump laser light is coupled into the gain fiber to energize the rare-earth ions and thereby produce laser action. The gain fiber is coupled between two fiber-optic mirrors to form a fiber-optic laser resonator. Fiber lasers are capable of generating high-power laser beams with high beam quality. When the core of the gain fiber is sufficiently small to accommodate only a single transverse mode, the generated laser beam is a single-mode beam. Such a single-mode fiber laser may generate a single-mode laser beam with average powers of several kilowatts. The all-fiber construction provides high stability, robustness, and excellent beam quality, thereby making fiber lasers a preferred laser source in many industrial, scientific, and medical applications.

Fiber lasers may be core-pumped or cladding-pumped, with the latter type being capable of generating the highest output powers. A typical cladding-pumped fiber laser is based on a double-clad gain fiber. The double-clad gain fiber has a core doped with rare-earth ions, an inner cladding supporting guided propagation of multi-mode pump laser light, and a protective outer cladding. The core guides signal laser light and may be designed to limit the signal laser light to a single transverse mode. The inner cladding is typically a silica cladding with a much larger cross-sectional area than the core. The outer cladding is typically made of a polymer with a significantly lower refractive index than the inner cladding, so as to provide a relatively large numerical aperture for guiding of the pump light in the combined volume of the inner cladding and the doped core. Pump light from a low-brightness multimode optical source, such as a laser diode or a laser diode array, can be coupled into the inner cladding due to its large cross-sectional area and high numerical aperture. Therefore, cladding-pumped fiber lasers are effective converters of low brightness radiation to high brightness radiation.

One of the challenges in designing high-power fiber lasers is managing the trade-off between pump power utilization and the onset of nonlinear effects in the gain fiber. Due to the small cross-sectional area of the gain-fiber core, within which the signal laser light is confined, the signal laser intensity can be quite high in the gain fiber. Fiber lasers are therefore relatively susceptible to adverse nonlinear effects. For example, the threshold for stimulated Raman scattering may be exceeded. Stimulated Raman scattering may convert a significant fraction of the signal laser light to a different wavelength, thereby effectively reducing the optical-to-optical efficiency (i.e., the ratio of signal laser power to pump laser power) of the fiber laser. This issue can be mitigated by shortening the gain fiber. However, shortening the gain fiber typically reduces the pump power utilization since the shortened length likely is insufficient to fully absorb the pump beam. In this scenario, some of the pump power passes through the gain fiber. Such waste of pump power also reduces the optical-to-optical efficiency.

The trade-off between pump power utilization and nonlinear effects has been addressed by redirecting the residual pump light back into the gain fiber, an approach referred to as “pump recycling”. A variety of pump recycling schemes have been suggested, with differing levels of complexity and capability. Simply coating the end facet of the gain fiber with a dichroic coating, configured to back-reflect the residual pump light, is not a feasible approach in the high-power scenarios where pump recycling is most useful. The dichroic coating will not be able to withstand the laser intensity incident thereon.

### SUMMARY

Disclosed herein is a fiber laser with a simple and robust pump recycler that can handle high-power pump laser light. The present pump recycler includes a tapered rod with a reflective coating on a distal end thereof. A proximal end of the tapered rod is coupled to a fiber-optic end mirror of the fiber-optic laser resonator. Residual pump laser light, not absorbed in a first pass through the gain fiber of the resonator, is coupled into the proximal end of the tapered rod. The residual pump laser light then propagates to the distal end, where the reflective coating reflects the pump laser light back to the laser resonator. The transverse cross-sectional area of the tapered rod increases adiabatically from a smaller cross-sectional area at the proximal end to a larger cross-sectional area at the distal end. Thus, during propagation of the residual pump laser light from the proximal end to the distal end, the diameter of the residual pump laser light increases adiabatically. Herein, a change in the geometry of a light-guiding tapered rod, along the length of the tapered rod, is considered “adiabatic” when the variation has substantially no effect on the mode-composition of guided light in the tapered rod. For example, the mode composition of at least 95% of the guided light may remain unchanged. The term “mode-composition” refers to the types of modes represented in the guided light, not necessarily the relatively power distribution between these modes.

Due to the larger diameter at the distal end, the reflective coating can withstand residual pump laser light of relatively high power, because the larger area of the distal end will cause the intensity of residual pump laser light incident thereon to be lower. The present fiber laser is therefore suitable for operation in high-power scenarios. In these scenarios, the present pump recycler may ensure high utilization of the pump laser light while facilitating reduction of the length of the gain fiber to avoid undesirable nonlinear effects, such as stimulated Raman scattering.

During propagation of reflected residual pump laser light from the distal end to the proximal end, the diameter of the residual pump laser light decreases adiabatically. The reflected residual pump laser light can therefore be coupled back into the fiber-optic laser resonator with low (or no) loss.

The tapered shape of the present pump recycler provides an additional advantage relating to the numerical aperture of the residual pump laser light. The adiabatic mode-diameter increase from the proximal end to the distal end is accompanied by an adiabatic decrease in the numerical aperture of the pump laser light. The spread of incidence angles onto the reflective coating at the distal end is therefore relatively small. The small spread of incidence angles may enable a coating design that is highly reflective at the wavelength of the pump laser light while being antireflective at other wavelengths where reflection is undesirable. For example, the coating may be antireflective at the wavelength of the signal laser light to prevent potentially damaging reflection of leaked signal laser light back into the laser resonator. The coating may also be antireflective, or at least have relatively low reflectivity, at wavelengths produced by nonlinear processes such as Raman scattering. It is preferable to minimize the reflection of Raman-scattered radiation back into the laser resonator.

In one aspect of the invention, a cladding-pumped fiber laser with pump recycling includes a fiber-optic laser resonator. The fiber-optic laser resonator includes a gain fiber having (a) an active core to generate and guide signal laser light and (b) surrounding the active core, a cladding to guide pump laser light. The fiber-optic laser resonator also includes a fiber-optic end mirror coupled to the gain fiber. The fiber-optic end mirror is reflective to the signal laser light and transmissive to the pump laser light. The fiber-optic laser resonator further includes a fiber-optic output coupler to couple a portion of the signal laser light out of the laser resonator. The gain fiber is coupled between the fiber-optic end mirror and the fiber-optic output coupler. Additionally, the fiber-optic laser resonator includes a pump combiner to couple the pump laser light into the gain fiber. The cladding-pumped fiber laser further includes a tapered rod to recycle residual pump laser light not absorbed by the gain fiber. The tapered rod includes (a) a proximal end arranged to receive the residual pump laser light from the gain fiber via the fiber-optic end mirror, and (b) a distal end, opposite the proximal end, having a reflective coating to at least partly reflect the residual pump laser light in direction back towards the gain fiber. A transverse cross-sectional area of the tapered rod adiabatically increases from a smaller transverse cross-sectional area at the proximal end to a larger transverse cross-sectional area at the distal end.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates a cladding-pumped fiber laser with pump recycling based on a tapered pump recycler, according to an embodiment.

FIG. 2 is a transverse cross section of an embodiment of a gain fiber of the FIG. 1 fiber laser.

FIG. 3 is a longitudinal cross section of an embodiment of the tapered pump recycler of the FIG. 1 fiber laser.

FIG. 4 shows exemplary end views of proximal and distal ends of a tapered rod of the pump recycler of the FIG. 1 fiber laser.

FIG. 5 illustrates an embodiment of the FIG. 1 fiber laser, wherein a tapered pump recycler is spliced to an optical fiber implementing a fiber-optic end mirror of a laser resonator of the fiber laser.

FIGS. 6A and 6B illustrates a holder that may be implemented in the FIG. 1 fiber laser to mechanically support the tapered pump recycler, according to an embodiment.

### DETAILED DESCRIPTION

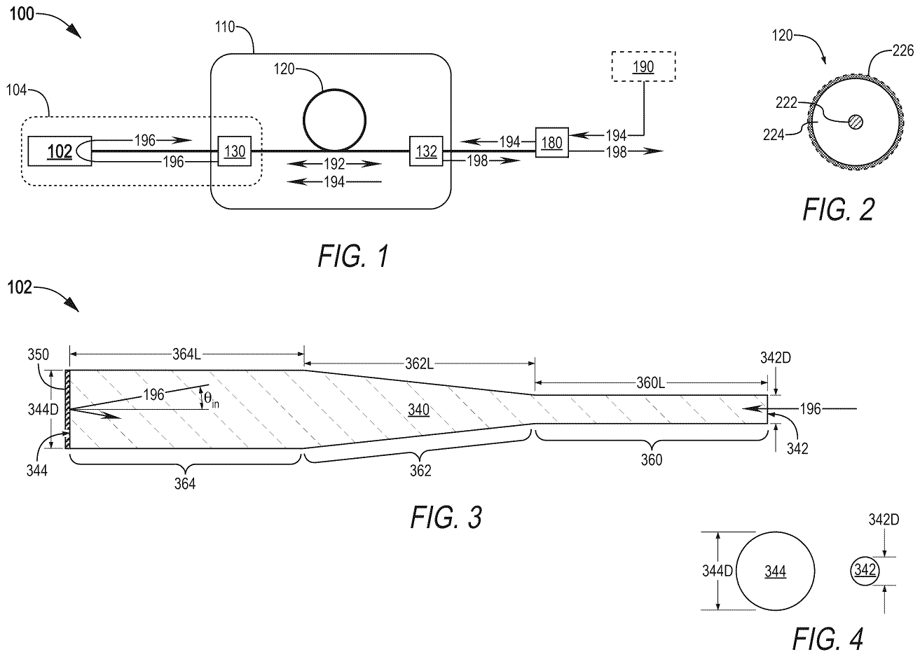

Referring now to the drawings, wherein like components are designated by like numerals, FIG. 1 illustrates one cladding-pumped fiber laser 100 with pump recycling based on a tapered pump recycler. Fiber laser 100 includes a fiber-optic laser resonator 110 and a tapered pump recycler 102. Resonator 110 includes a gain fiber 120, a fiber-optic end mirror 130, and a fiber-optic output coupler 132. Each of end mirror 130 and output coupler 132 may be implemented in a respective optical fiber, for example as a fiber Bragg grating. Fiber laser 100 further includes a pump combiner 180, which may be a fiber-optic component.

FIG. 2 illustrates gain fiber 120 in transverse cross section. Herein, the term “longitudinal” refers to a dimension of an optical element that is parallel to the general propagation direction of light through the optical element, and the term “transverse” refers to dimensions of the optical element that are orthogonal to the longitudinal axis of the optical element. Gain fiber 120 includes an optically-active core 222 and a surrounding inner cladding 224. Optionally, gain fiber 120 is a double-clad fiber that further includes an outer cladding 226. Active core 222 may be made of a glass, such as fused silica, that is doped with rare-earth ions. Inner cladding 224 may be made of a glass characterized by a lower refractive index than active core 222. In one example, inner cladding 224 is made of undoped fused silica. Outer cladding 226 may be made of a polymer characterized by a lower refractive index than inner cladding 224.

Referring again to FIG. 1, end mirror 130 is coupled, directly or indirectly, to gain fiber 120. Gain fiber 120 is coupled between end mirror 130 and output coupler 132. Gain fiber 120 may be coupled directly or indirectly to each of end mirror 130 and output coupler 132. In operation, pump combiner 180 couples pump laser light 194 into resonator 110 and gain fiber 120, optionally via output coupler 132 as depicted in FIG. 1. Gain fiber 120 guides pump laser light 194 in the combined volume of inner cladding 224 and active core 222. Pump laser light 194 energizes active core 222 to generate signal laser light 192 that is then guided in active core 222. A portion of signal laser light 192 circulating in resonator 110 is coupled out of resonator 110 via output coupler 132 to produce an output laser beam 198.

In the depicted embodiment, pump combiner 180 is positioned outside resonator 110, such that output laser beam 198 and pump laser light 194 propagate in opposite directions between output coupler 132 and pump combiner 180. In this embodiment, pump laser light 194 is coupled into resonator 110 via output coupler 132, and pump combiner 180 separates output laser beam 198 from the counter-propagating pump laser light 194. In an alternative embodiment, not depicted, the order of pump combiner 180 and output coupler 132 is switched, such that pump laser light 194 bypasses output coupler 132, and output laser beam 198 does not encounter pump combiner 180 outside resonator 110.

Fiber laser 100 may include a pump laser 190 that generates pump laser light 194. Pump laser 190 may be fiber-coupled to pump combiner 180. Embodiments of fiber laser 100 that do not include pump laser 190 are configured to be implemented in conjunction with a separately-obtained pump laser 190.

Pump laser light 194 and signal laser light 192 may both be near-infrared. In one example, the wavelength of signal laser light 192 is in the range between 1000 and 1100 nanometers (nm), or 1900 and 2000 nm, and the wavelength of pump laser light 194 is between 910 and 945 nm, between 960 and 980 nm, or between 780 and 820 nm.

End mirror 130 is reflective at the wavelength of signal laser light 192 but transmissive at the wavelength of pump laser light 194. In one example, end mirror 130 is at least 95% reflective to signal laser light 192 and at least 99% transmissive to pump laser light 194. These reflection and transmission coefficients may apply to respective near-infrared wavelengths, for example any one of the associated exemplary wavelength ranges listed above. In a typical scenario, not all pump laser light 194 is absorbed by gain fiber 120 in the first pass therethrough (right to left in FIG. 1). A residual portion of pump laser light 194, referred to as residual pump laser light 196, is coupled out of resonator 110 via end mirror 130. Pump recycler 102 receives residual pump laser light 196 from gain fiber 120 via end mirror 130. Pump recycler 102 reflects at least a portion (e.g., at least 75% or at least 90%) of residual pump laser light 196 back toward gain fiber 120 for a second pass therethrough (left to right in FIG. 1). This pump recycling may allow for shortening the length of gain fiber 120, as compared to a similar fiber laser that does not include pump recycler 102. By virtue of pump recycler 102, fiber laser 100 may (a) reduce the occurrence of undesirable nonlinear effects, such as stimulated Raman scattering, while (b) optimizing utilization of the power of pump laser light 194 to achieve a high optical-to-optical conversion efficiency.

FIG. 3 illustrates tapered pump recycler 102 in longitudinal cross section. Pump recycler 102 includes a tapered rod 340 having a proximal end 342 and a distal end 344. In fiber laser 100, proximal end 342 is coupled, directly or indirectly, to end mirror 130. In one embodiment, proximal end 342 is spliced to an optical fiber that implements end mirror 130. In another embodiment, one or more optical fibers or fiber components are spliced between proximal end 342 and an optical fiber implementing end mirror 130. Tapered rod 340 may be made of glass, for example the same glass as an optical fiber to which proximal end 342 is spliced. In one example, tapered rod 340 is made of the same material as inner cladding 224 of gain fiber 120, e.g., fused silica. Tapered rod 340 may be rigid or flexible, and the rigidity of tapered rod 340 may vary along its length. Tapered rod 340 may be a tapered core of an optical fiber.

Pump recycler 102 further includes a reflective coating 350 on distal end 344. Reflective coating 350 is reflective at the wavelength of pump laser light 194 (and thus residual pump laser light 196). In one example, reflective coating 350 is at least 95% reflective at the wavelength of pump laser light 194. This reflection coefficient may apply to a near-infrared wavelength, such as any one of the associated exemplary wavelength ranges listed above for pump light 194. Reflective coating 350 may be a multi-layer dielectric coating.

FIG. 4 are end views of proximal end 342 and distal end 344. The transverse cross-sectional area of distal end 344 is larger than the transverse cross-sectional area of proximal end 342. In the depicted embodiment, ends 342 and 344 are circular. Without departing from the scope hereof, one or both of ends 342 and 344 may have a different shape, for example oval or hexagonal. Without loss of generality, the following discussion assumes that ends 342 and 344 are circular and thus characterized by respective diameters 342D and 344D. For non-circular cross sections, diameters 342D and 344D may instead be thought of as a characteristic transverse extent.

Referring again to FIG. 3, in operation of fiber laser 100, residual pump laser light 196 enters tapered rod 340 via proximal end 342 and propagates toward reflective coating 350 on distal end 344. Tapered rod 340 includes a tapered segment 362 where the diameter of tapered rod 340 increases from the diameter 342D of proximal end 342 to diameter 344D of distal end 344. In the depicted embodiment, this increase is linear. In other embodiments, the increase in diameter along tapered segment 362 is nonlinear or even non-monotonic. However, the increase from diameter 342D to diameter 344D is adiabatic, such that the mode-composition of residual pump laser light 196 is at least substantially unchanged.

In one embodiment, the ratio of the relative diameter increase to the length over which the increase takes place is less than 1 mm⁻¹. The “relative diameter increase” can be expressed as (D₂−D₁)/D₁, wherein D₁ is diameter 342D and D₂ is diameter 344D. Thus, in this embodiment,

$$( \frac{( {D}_{2} - {D}_{1} )}{{D}_{1}} ) / L < 1 {mm}^{- 1} ,$$

wherein L is the length over which the diameter increase takes place. This condition may apply to the full length of tapered segment 362 as well as to any sub-segments thereof. In another embodiment, the relative rate of change of the diameter,

$$\vert \frac{d D ( z )}{d z} \vert / D ( z ) ,$$

is less than 1 mm⁻¹, wherein the diameter of tapered segment 362 is referred to as D(z) and z is a lengthwise coordinate. This condition may apply to any location along the length of tapered segment 362. In yet another embodiment,

$$( \frac{( {A}_{2} - {A}_{1} )}{{A}_{1}} ) / L < 4 {mm}^{- 1} ,$$

wherein A₁ is the cross-sectional area of the smallest end of tapered segment 362 and A₂ is the cross-sectional area of the largest end of tapered segment 362. This condition may apply to the full length of tapered segment 362 as well as to any sub-segments thereof. In a further embodiment,

$$\vert \frac{d A ( z )}{d z} \vert / A ( z ) < 4 {mm}^{- 1} ,$$

wherein A(z) is the cross-sectional area of tapered segment 362 as a function of lengthwise coordinate z. This condition may apply to any location along the length of tapered segment 362.

The adiabatically tapered shape of tapered rod 340 has several functions and advantages. This shape ensures an increased transverse cross-sectional area and thus reduced power density (i.e., irradiance) of residual pump laser light 196 at distal end 344, as compared to at proximal end 342, such that reflective coating 350 can withstand residual pump laser light 196 of relatively high power. The tapered shape allows for low-loss coupling of reflected residual pump laser light 196 back into gain fiber 120. In addition, the tapered shape facilitates a coating design for reflective coating 350 that can be highly reflective at the wavelength of residual pump laser light 196 while being highly transmissive, and optionally even anti-reflective, at other wavelengths of relevance, such as the wavelengths of signal laser light 192 and Raman-scattered radiation leaking through end mirror 130.

As residual pump laser light 196 propagates through tapered segment 362 in the direction toward distal end 344, the diameter of residual pump laser light 196 increases adiabatically, and the numerical aperture of residual pump laser light 196 decreases adiabatically. After reflection by reflective coating 350, residual pump laser light 196 propagates back to proximal end 342. As residual pump laser light 196 passes through tapered segment 362, the diameter of residual pump laser light 196 decreases, and the numerical aperture of residual pump laser light 196 increases. These changes are adiabatic. When reaching proximal end 342, the reflected residual pump laser light 196 has substantially the same mode-composition, diameter, and numerical aperture as when first entering tapered rod 340. It is therefore possible to couple the reflected residual pump laser light 196 back into gain fiber 120 with little or no loss.

In the interest of eliminating or minimizing coupling loss of residual pump laser light 196 from gain fiber 120 to tapered rod 340, the (internal) numerical aperture of tapered rod 340 may be at least as large as the numerical aperture imposed on pump laser light 194 by inner cladding 224 of gain fiber 120. In some embodiments, the numerical aperture of pump laser light 194 in gain fiber 120 is determined by the refractive index contrast at the outer surface of inner cladding 224 of gain fiber 120. In this manner, gain fiber 120 imposes a numerical aperture on pump laser light 194. Residual pump laser light 196 may be characterized by this same numerical aperture when entering tapered rod 340. Thus, in an embodiment configured to prevent a coupling loss at this point, the numerical-aperture-limit imposed on residual pump laser light 196 at the proximal end of tapered rod 340 is at least as high as that imposed on pump laser light 194 by gain fiber 120. In one example, where tapered rod 340 is made of fused silica, the (internal) numerical aperture at the proximal end of tapered rod 340 is at least 0.35 or at least 0.45. The outer surface of tapered rod 340 may interface primarily with air or may have an outer cladding.

At distal end 344, the increased diameter of residual pump laser light 196 results in a reduced power density on reflective coating 350. Pump recycler 102 is therefore capable of handling residual pump laser light 196 of relatively high power. The power of residual pump laser light 196 is a function of both (a) the power of pump laser light 194 coupled into resonator 110 and (b) the fraction of pump laser light 194 that passes through gain fiber 120 unabsorbed. Thus, the adiabatic tapering of tapered rod 340 to the larger transverse cross-sectional area of distal end 344 allows for (a) coupling relatively high-power pump laser light 194 into resonator 110 and/or (b) recycling of a relatively high fraction of the power of pump laser light 194 coupled into resonator 110. In one scenario, at least 3 kW of pump laser light 194 power is coupled into resonator 110, and at most 85% of that initial power is absorbed in the first pass through gain fiber 120 while the remaining power enters pump recycler 102 for recycling. The incorporation of pump recycler 102 may facilitate operation of fiber laser 100 at high power. For example, output laser beam 198 may have a power of at least one kilowatt (kW), e.g., in the range between 1 and 5 kW.

The transverse area of distal end 344 may be at least four times the transverse area of proximal end 342 in order to provide significant benefits in terms of maximizing the power of output laser beam 198 and minimizing the risk of undesirable nonlinear processes in gain fiber 120. In one implementation, the transverse area of distal end 344 is between four and ten times the transverse area of proximal end 342. The transverse area of distal end 344 may be at least 0.5 mm². Tapered segment 362 may have a length 362L of at least 5 mm or at least 10 mm, e.g., between 10 and 20 mm, to ensure that the diameter and numerical aperture of residual pump laser light 196 change adiabatically during propagation through tapered segment 362. In embodiments with circular transverse cross sections, diameter 344D may be at least twice as large as diameter 342D, and diameter 342D may be in the range between 200 and 600 micrometers (μm).

The decreased numerical aperture of residual pump laser light 196 at distal end 344 is advantageous for the design and performance of reflective coating 350. The decreased numerical aperture corresponds to a decreased spread of internal incidence angles θᵢₙ onto reflective coating 350. The range of incidence angles onto reflective coating 350 is typically centered around normal incidence. In one example, the numerical aperture of residual pump laser light 196 at distal end 344 is no more than half the numerical aperture of residual pump laser light 196 at proximal end 342. Accordingly, the maximum value of θᵢₙ (at the 1/e² level) onto reflective coating 350 is at most half of what this maximum value would have been if distal end 344 had the same transverse cross-sectional area as proximal end 342. For example, the maximum value of θᵢₙ (at the 1/e² level) may be less than 10 degrees. The reduced internal incidence angles θᵢₙ onto reflective coating 350 makes it possible, or at least easier, to design a reflective coating that is highly reflective at the wavelength of residual pump laser light 196. For example, reflective coating 350 may be designed to be reflective at the wavelength of residual pump laser light 196 while being antireflective at the wavelength of signal laser light 192. Such a reflective coating may also be antireflective at the wavelengths of Raman-scattered radiation potentially generated in gain fiber 120 and transmitted by end mirror 130.

In one example, the (internal) numerical aperture of residual pump laser light 196 at proximal end 342 is 0.3, and the transverse cross-sectional area of distal end 344 is three times the transverse cross-sectional area of proximal end 342. In this example, the numerical aperture of residual pump laser light 196 at distal end 344 is 0.17. When tapered rod 340 is made of fused silica, this distal numerical aperture of residual pump laser light 196 corresponds to the maximum internal incidence angle θᵢₙ onto reflective coating 350 being less than 10 degrees (at the 1/e² level). In another example, the (internal) numerical aperture of residual pump laser light 196 at proximal end 342 is 0.2, the transverse cross-sectional area of distal end 344 is twice the transverse cross-sectional area of proximal end 342, tapered rod 340 is made of fused silica, and the maximum internal incidence angle θᵢₙ onto reflective coating 350 is therefore about 8.1 degrees (at the 1/e² level).

Tapered segment 362 may span the entire length of tapered rod 340 from proximal end 342 to distal end 344. However, tapered rod 340 may also include one or more constant-cross-section segments (characterized by a constant transverse cross section along its longitudinal extent) next to tapered segment 362 or interspersed within tapered segment 362. In the embodiment depicted in FIG. 3, tapered rod 340 includes two such constant-cross-section segments of non-zero longitudinal extent: a proximal constant-cross-section segment 360 at the proximal end of tapered rod 340 and a distal constant-cross-section segment 364 at the distal end of tapered rod 340. Proximal constant-cross-section segment 360 has the same transverse cross section as proximal end 342. Distal constant-cross-section segment 364 has the same transverse cross section as distal end 344. In this embodiment, tapered segment 362 provides an adiabatic transition between these two transverse cross sections. Each of constant-cross-section segments 360 and 364 may have cylindrical cross sections, and tapered segment 362 may be shaped as a truncated cone.

Constant-cross-section segments 360 and 364 may be advantageous for handling and implementation of pump recycler 102. Proximal constant-cross-section segment 360 may simplify splicing of tapered rod 340 to an optical fiber delivering residual pump laser light 196 to tapered rod 340. Distal constant-cross-section segment 364 may provide a practical interface for mechanically supporting this bulkier end of tapered rod 340. The respective lengths 360L and 364L of constant-cross-section segments 360 and 364 may each be in the range between 5 and 50 mm. Generally, tapered rod 340 may include one, both, or none of constant-cross-section segments 360 and 364.

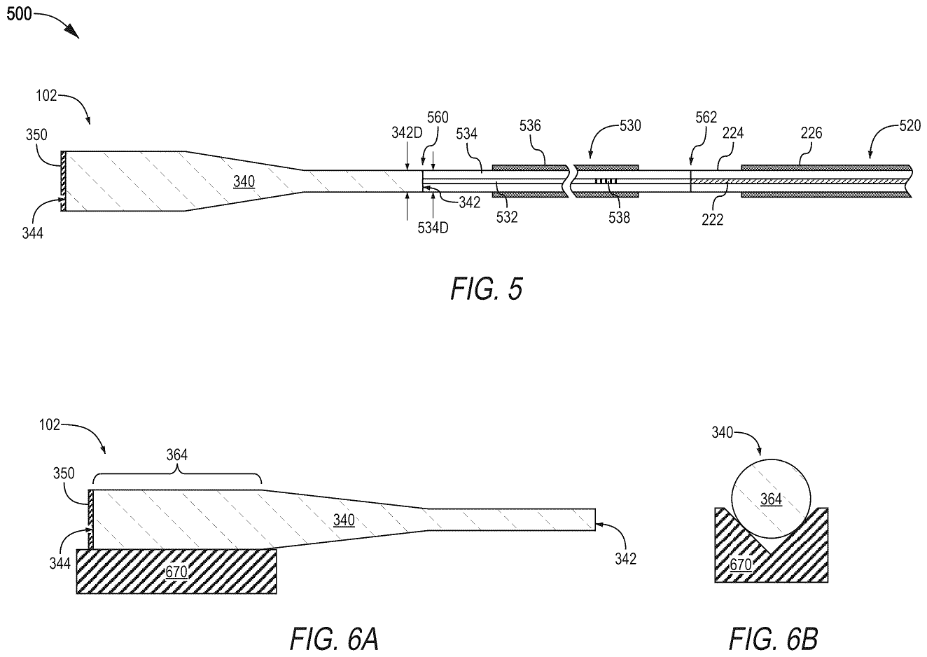

FIG. 5 illustrates one cladding-pumped fiber laser 500 with pump recycling, wherein pump recycler 102 is spliced to an optical fiber implementing end mirror 130. Fiber laser 500 is an embodiment of fiber laser 100. Fiber laser 500 implements gain fiber 120 as a double-clad gain fiber 520 that includes outer cladding 226. In fiber laser 500, end mirror 130 is a fiber Bragg grating 538 in an optical fiber 530. Optical fiber 530 is spliced between gain fiber 520 and pump recycler 102. Proximal end 342 is spliced to one end of optical fiber 530 at splice 560. The opposite end of optical fiber 530 is spliced to gain fiber 520 at splice 562. For clarity of illustration, FIG. 5 shows only a portion of fiber laser 500 extending from pump recycler 102 to a location along the length of gain fiber 520. This portion is indicated in FIG. 1 as portion 104.

In the depicted embodiment, optical fiber 530 is a double-clad fiber having a core 532, an inner cladding 534, and an outer cladding 536. Outer cladding 536 is stripped from optical fiber 530 near splices 560 and 562 to enable splicing. Similarly, outer cladding 226 is stripped from gain fiber 520 near splice 562. The stripped and spliced sections of fiber may subsequently be reclad.

At splice 560, the transverse cross section of proximal end 342 matches the combined transverse cross section of core 532 and inner cladding 534 of optical fiber 530, in size, shape, and location. (For example, in implementations with circular cross sections, diameter 342D matches the outer diameter 534D of inner cladding 534.) This ensures that residual pump laser light 196 can be coupled between optical fiber 530 and pump recycler 102 with no or minimal loss. Similarly, at splice 562, the combined transverse cross section of core 532 and inner cladding 534 of optical fiber 530 may approximately match the combined transverse cross section of active core 222 and inner cladding 224 of gain fiber 520, in size, shape, and location. The transverse cross section of core 532 of optical fiber 530 may approximately match the transverse cross section of active core 222 of gain fiber 520, in size, shape, and location, such that signal laser light 192 is coupled between active core 222 of gain fiber 520 and core 532 of optical fiber 530. Fiber Bragg grating 538 may be implemented in only core 532, as depicted, or may extend beyond core 532.

Although not shown in FIG. 5, fiber laser 500 may include one or more transport fibers spliced between pump recycler 102 and optical fiber 530 and/or spliced between optical fiber 530 and gain fiber 520. Preferably, to prevent undesirable coupling losses, the transverse cross sections are matched at each splice.

FIGS. 6A and 6B are orthogonal cross-sectional views of a holder 670 that may be implemented in fiber laser 100 to mechanically support an embodiment of pump recycler 102 that includes distal constant-cross-section segment 364. Holder 670 supports distal constant-cross-section segment 364. For example, as depicted in FIG. 6B, distal constant-cross-section segment 364 may be seated in a groove of holder 670. Holder 670 benefits from distal constant-cross-section segment 364 having a constant transverse cross section along its longitudinal extent. Distal constant-cross-section segment 364 is, for example, secured to holder 670 by an adhesive. This adhesive may be a low-refractive-index glue, to prevent coupling of residual pump laser light 196 into the adhesive. In some embodiments, a low-refractive-index glue is applied to the entire interface between distal constant-cross-section segment 364 and holder 670 to prevent loss of residual pump laser light 196 to holder 670.

The present invention is described above in terms of a preferred embodiment and other embodiments. The invention is not limited, however, to the embodiments described and depicted herein. Rather, the invention is limited only by the claims appended hereto.

What is claimed is:

1. A cladding-pumped fiber laser with pump recycling, comprising:
a fiber-optic laser resonator including:
a gain fiber having (a) an active core to generate and guide signal laser light and (b) surrounding the active core, a cladding to guide pump laser light,
a fiber-optic end mirror coupled to the gain fiber, the fiber-optic end mirror being reflective to the signal laser light and transmissive to the pump laser light,
a fiber-optic output coupler to couple a portion of the signal laser light out of the laser resonator, the gain fiber coupled between the fiber-optic end mirror and the fiber-optic output coupler, and
a pump combiner to couple the pump laser light into the gain fiber; and
a tapered rod to recycle residual pump laser light not absorbed by the gain fiber, the tapered rod including:
a proximal end arranged to receive the residual pump laser light from the gain fiber via the fiber-optic end mirror, and
a distal end, opposite the proximal end, having a reflective coating to at least partly reflect the residual pump laser light in a direction back towards the gain fiber;
wherein a transverse cross-sectional area of the tapered rod adiabatically increases from a smaller transverse cross-sectional area at the proximal end to a larger transverse cross-sectional area at the distal end.

2. The fiber laser of claim 1, wherein the larger transverse cross-sectional area is at least 0.5 square millimeters.

3. The fiber laser of claim 1, wherein the reflective coating is disposed on a planar surface of the distal end, the planar surface being orthogonal to a longitudinal axis of the tapered rod.

4. The fiber laser of claim 1, wherein the larger transverse cross-sectional area is at least four times the smaller transverse cross-sectional area.

5. The fiber laser of claim 1, wherein the proximal end is spliced to a passive optical fiber that contains or is coupled to the fiber-optic end mirror.

6. The fiber laser of claim 5, wherein the smaller transverse cross-sectional area of the proximal end matches an adjacent transverse cross-sectional area of the passive optical fiber in shape and size.

7. The fiber laser of claim 1, wherein the transverse cross-sectional area of the tapered rod is circular.

8. The fiber laser of claim 7, wherein the proximal end has a proximal diameter in the range between 200 and 600 micrometers, and a distal diameter of the distal end is at least twice the proximal diameter.

9. The fiber laser of claim 8, wherein the transverse cross-sectional area of the tapered rod increases from the smaller transverse cross-sectional area to the larger transverse cross-sectional area over a longitudinal distance of at least 5 millimeters.

10. The fiber laser of claim 1, wherein the gain fiber imposes a first upper limit on the numerical aperture of the pump laser light propagating therein, and the tapered rod imposes a second upper limit on the residual pump laser light propagating therein, the second upper limit being at least as high as the first upper limit.

11. The fiber laser of claim 10, wherein the first upper limit is at least 0.35.

12. The fiber laser of claim 10, wherein the tapered rod decreases the numerical aperture of the residual pump light from a proximal numerical aperture at the proximal end to a distal numerical aperture at the distal end, the distal numerical aperture being no more than half the proximal numerical aperture.

13. The fiber laser of claim 1, wherein the tapered rod includes:
a proximal segment forming the proximal end, the proximal segment having non-zero longitudinal extent and being characterized by the smaller transverse cross-sectional area,
a distal segment forming the distal end, the distal segment having non-zero longitudinal extent and being characterized by the larger transverse cross-sectional area, and
a tapered segment connecting the proximal and distal segments to each other, the transverse cross-sectional area of the tapered segment gradually increasing from the proximal segment to the distal segment.

14. The fiber laser of claim 13, wherein each of the proximal and distal segments is cylindrical, and the tapered segment is a truncated cone.

15. The fiber laser of claim 14, further comprising a holder supporting the distal segment.

16. The fiber laser of claim 1, wherein the reflective coating is reflective at wavelength of the pump laser light and antireflective at wavelength of the signal laser light.

17. The fiber laser of claim 1, wherein the tapered rod includes fused silica.

18. The fiber laser of claim 1, further comprising a pump laser to generate the pump laser light, the pump laser being optically coupled to the pump combiner.

19. The fiber laser of claim 1, wherein the fiber-optic output coupler is coupled between the gain fiber and the pump combiner.

20. The fiber laser of claim 1, wherein the pump combiner is coupled between the fiber-optic output coupler and the gain fiber.
